(19) United States
(12) Patent Application Publication
(10) Pub. No.: US 2004/0107199 A1
(43) Pub. Date: Jun. 3, 2004

(54) Computer application backup method and system

(75) Inventors: Philip W. Dalrymple III, Acworth, GA (US); Robert A. Gargan JR., Alpharetta, GA (US); Daniel N. Hennessy, Monroeville, PA (US)

Correspondence Address: Thomas E. Kocovsky, Jr., FAY, SHARPE, FAGAN, MINNICH & McKEE, LLP, Seventh Floor, 1100 Superior Avenue, Cleveland, OH, 44114-2518, US

(73) Assignee: MDT INC.

(21) Appl. No.: 10/624,200

(22) Filed: Jul. 22, 2003

Related U.S. Application Data
(60) Provisional application No. 60/405,276, filed on Aug. 22, 2002.

(51) Int. Cl. G06F 17/00

(52) U.S. Cl. 707/100

(57) ABSTRACT

In a method for backing up (100) and restoring (150) an application program associated with a computer (20) having an operating system with a common applications registry, an image backup is created (102) of one or more storage media (22, 24) that store files associated with the application program including the common applications registry. An initial application program backup is created (104) including files associated with the application program and entries of the common applications registry pertaining to the application program. The one or more storage media (22, 24) are periodically inventoried (110) to detect a change in a file or a change in an entry of the common applications registry pertaining to the application program. Responsive to a detected change, an update application program backup is created (124) including files associated with the application program and entries of the common applications registry pertaining to the application program.

### BACKGROUND OF THE INVENTION

The present invention relates to the computer and information processing arts. It particularly relates to backup of computer application software programs, and will be described with particular reference thereto. However, the invention will also find application in porting applications between computers, in detecting malicious computer viruses, worms, Trojan horses, and the like, in resolving library and other resource conflicts between application programs, and in other aspects of the computer and information processing arts.

A computer typically includes a hard disk drive or other random access non-volatile storage medium that is divided into one or more partitions. If the hard disk drive includes multiple partitions, each partition typically appears as a separate disk when accessed by the computer. The hard disk drive or other random access non-volatile storage medium stores an operating system and various types of applications software. The operating system provides overall coordination for operation of the computer. Application programs are loaded and executed under control of the operating system. In a multi-tasking operating system, a plurality of application programs can be loaded and executing concurrently. Access to computer resources such as hard disk space, computer memory segments, and the like are controlled by the operating system. An application program communicates a resource request to the operating system, and in response the operating system allocates the resource, or a portion thereof, to the application program. If a plurality of application programs are executing concurrently, resource allocation between applications is decided by the operating system based on a priority ranking or other suitable decision method.

Typically, each application program includes one or more files stored on the hard disk or other non-volatile storage medium, and/or on other non-volatile storage media. To permit users to customize an application, a registry is maintained that stores customized program parameters, settings, and other configuration parameters. To consider one example, in a word processing application such parameters may include a default font size and style, a default data file path, a default data file format, personalized hotkeys for performing commonly-used functions, a foreign language selection, a link to an equation editor, an image editor, or other supplemental application, and the like.

Moreover, the operating system typically maintains an operating system registry containing default parameters or other settings for the operating system. In an operating system designed to accommodate multiple users, the operating system registry contains personalized parameters, default settings, and the like for each user.

In certain operating systems, such as the Windows family of operating systems and the NT family of operating systems, a single common registry is maintained by the operating system that contains the parameters, settings, and et cetera for the operating system and for the various program applications. This arrangement has certain benefits. For example, global parameters such as a global default font size and style can be maintained for each user, so that every application accessed by that user will employ the common default font size and style.

Similarly, with a common registry a single pointer parameter can be used to identify a library or other system resource that is accessed by a number of different application programs. The use of a single common registry for applications avoids storage overhead of separate registries for each application and for each different computer user profile, which can save disk space and reduce file allocation table size and complexity.

However, the common registry of Windows, NT, and certain other operating systems has a substantial disadvantage in that it intermingles parameters and settings of the various applications. This complicates recovery of a corrupted application program. Such program corruption can occur, for example, when a new application is loaded that updates libraries or other resources used by existing applications in a manner which is incompatible with the existing applications.

Preferably, recovery of a corrupted application program is achieved by reloading the latest backup of the affected files, assuming such a backup has been maintained. However, with an operating system employing a common registry this reloading must include loading a backup of the common registry. Reloading a common registry backup, in turn, affects all the application programs on the computer. The reloading erases updates to other, uncorrupted application programs that were made after the reloaded backup was created, and can even cause other application programs to become corrupted if the old configuration parameters for those applications do not comport with existing hardware.

Moreover, the common registry complicates system cleanup. As is known in the art, over time a computer typically becomes increasingly inefficient due to an accumulation of application programs that are no longer used, orphaned files associated with earlier versions of application programs that remain after upgrades, accumulation of corrupted disk sectors, and the like. Such problems can be addressed by reformatting the hard disk or other non-volatile storage medium, reloading the operating system (or an upgrade thereof), and reloading the application software. However, this effectively erases the default parameters, settings, and other configuration aspects which were stored in the registry.

As an alternative, an image backup of the hard disk drive or other non-volatile storage medium can be performed prior to the cleanup reformatting, and the image backup restored after the reformatting. This procedure can correct corrupted disk sectors and certain other accumulated defects while retaining user configuration information. However, it does not remove outdated applications, orphaned files, and other debris that are restored when the image backup is copied back onto the formatted drive.

Yet another disadvantage of the common registry is that it prevents convenient transfer of an application including configuration parameters to another computer. While the files associated with the application may be readily transferable, the configuration parameters stored in the common registry are not. This registry typically cannot be copied over to the other computer without hopelessly corrupting other application programs and possibly even the operating system itself. Hence, to transfer an application program to another computer, the user must install the application program on the new computer and manually set or change defaults, update settings, or otherwise configure the application program to match the configuration of the first computer. The reconfiguration process is time consuming, labor-intensive, and imprecise.

Still yet another disadvantage of the common registry is that it delays recovery of critical systems which have been infected by a virus or other malicious and destructive software program. Because it is usually impossible to ascertain which files have been infected by a computer virus, a typical response to a virus infection is to reformat the hard disk or other non-volatile storage medium and restore an image backup of the hard disk or other non-volatile memory. For older or heavily used computers with a large amount of the disk space occupied by a myriad of application programs, this can be a time consuming process. Furthermore, because the image backup does not index the stored information by application, the entire image backup including non-essential or even unused programs and files must be restored before the computer regains any functionality. This can be particularly problematic for a computer system that runs a critical application program that needs to be quickly restored after a viral infection or other catastrophic event.

The present invention contemplates an improved apparatus and method that overcomes the aforementioned limitations and others.

### SUMMARY OF THE INVENTION

According to one aspect of the invention, a method is provided for backing up and restoring an application program including an application program configuration. The application program is associated with a computer that includes an operating system with a common applications registry. An image backup is created of one or more storage media that store files associated with the application program. An initial application program backup is created of the application program including backing up files associated with the application program. The one or more storage media are periodically inventoried to detect a change in a file associated with the application program. Responsive to a detected change, an update application program backup is created of the application program including backing up files associated with the application program.

According to another aspect of the invention, a system is disclosed for backing up and restoring an application program including an application program configuration. The application program is associated with a computer that includes an operating system with a common applications registry. An application program backup software program is provided for creating an application program backup of the application program including copies of files associated with the application program that reside on one or more storage media and copies of entries of the common applications registry pertaining to the application program. The application program backup software program assigns a creation date to each created application program backup corresponding to a date of creation thereof. A backup coordinating software program invokes the application program backup software program to create an initial application program backup, periodically inventories the one or more storage media to detect one of a change in a file associated with the application program and a change in an entry of the common applications registry pertaining to the application program, and invokes the application program backup software program to create an update application program backup responsive to a detected change. A restore software program is provided for restoring the application program to a state corresponding to a selected creation date by copying information contained in an application program backup having the selected creation date onto the one or more storage media.

One advantage of the present invention resides in selective restoration of an application program after a reformatting of the hard disk or other non-volatile storage medium, or after corruption of the application program by installation of another program or other event.

Another advantage of the present invention resides in improved efficiency and selectivity in recovering a computer after a cleanup reformatting of the hard drive or other non-volatile storage medium, or after a catastrophic disk failure, a computer virus infection, or other event which necessitates reformatting of the hard drive or other non-volatile storage medium.

Yet another advantage of the present invention resides in improved portability of application programs including configurations therefor between computers.

Still yet another advantage of the present invention resides in early detection and notification of modifications to an application program that can be indicative of an application program conflict or activity of a virus or other malicious software program.

Numerous additional advantages and benefits of the present invention will become apparent to those of ordinary skill in the art upon reading the following detailed description of the preferred embodiment.

### BRIEF DESCRIPTION OF THE DRAWINGS

The invention may take form in various components and arrangements of components, and in various steps and arrangements of steps. The drawings are only for the purpose of illustrating preferred embodiments and are not to be construed as limiting the invention.

FIG. 1 shows a networked computer system with application program backup and restore capability.

FIG. 2 shows a preferred application program backup method.

FIG. 3 shows a preferred application program restore method.

### DETAILED DESCRIPTION OF THE PREFERRED EMBODIMENTS

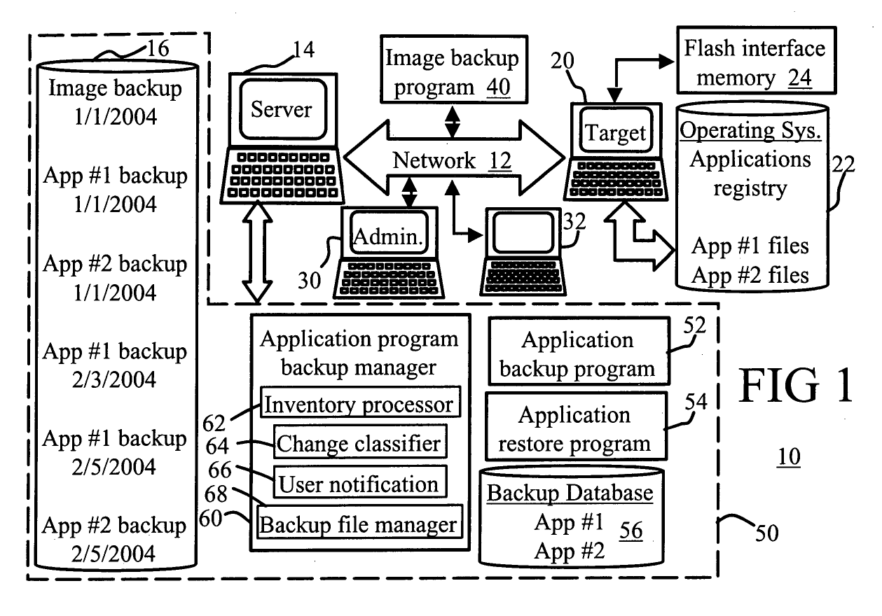

With reference to FIG. 1, a networked computer system 10 includes a digital communication network 12 such as a TCP/IP network or the like. A network server computer 14 connected to the network 12 includes or has access to at least one non-volatile storage medium 16, such as a large-capacity hard disk, a tape backup system, an optical read/write disk, and/or the like. The non-volatile storage medium 16 is optionally divided into one or more partitions which appear on the network server computer 14 as individual logical drives.

A target computer 20 also connected to the network 12 includes or has access to at least one non-volatile storage medium 22, such as an internal hard disk drive, which is preferably divided into one or more partitions. At least one partition of the storage medium 22 stores files corresponding an operating system. A plurality of applications including exemplary applications “App #1” and “App #2” are stored on the partition containing the operating system, on another partition of the storage medium 22, or on another storage medium connected with the target computer 20 or accessible by the target computer 20 via the network 12.

A common applications registry associated with the operating system is also stored on the storage medium 22, and contains default parameters, settings, and other configuration information for the various applications including “App #1” and “App #2”. Optionally, the operating system supports multiple users by maintaining separate and distinct user profiles. In this case, the common applications registry typically includes separate configuration parameters for each application and for each user profile. Optionally, the common applications registry also contains default parameters, settings, and other configuration information for the operating system itself.

In addition to the main hard disk or other principle non-volatile storage medium 22, the target computer 20 optionally further contains or has access to secondary non-volatile storage media such as a flash interface memory 24 that contains information particularly pertaining to one or more specific application programs.

In addition to the server computer 14 and the target computer 20, the network 12 typically includes additional computers connected thereto, such as an exemplary system administrator's computer 30, and an exemplary additional computer 32. Each computer of the network typically includes a hard disk or other non-volatile storage medium associated therewith that contains an operating system, selected application programs, data files, and the like. As is known in the art, the various computers connected with the network 12 need not include identical or even similar operating systems. Rather, each computer on the network 12 can have a distinct operating system. Data is transferred between computers on the network 12 using a selected network protocol, such as a TCP/IP network protocol.

In order to provide backup and restore capability for various non-volatile storage media connected to the network including the hard disk or other storage medium 22 (or a selected partition thereof) of the target computer 20, an image backup program 40 is provided. As is known in the art, the image backup program creates an image copy, i.e. an exact bit-for-bit copy, of the contents of the backed-up non-volatile storage medium or a partition thereof to a backup non-volatile storage medium.

In the illustrated networked system 10 the backup medium is the high-capacity non-volatile storage medium 16 included in or accessed by the network server computer 14. The image backup can be restored in a straightforward manner by copying the image copy back onto the source medium 22. Depending upon the backup file format or other specific aspects, such restoration can be performed by the image backup program 40, by a separate corresponding restore program (not shown), or by information transfer operations of the network 12. It is also contemplated to integrate the image backup functions of the image backup program 40 into the network 12 or the server 14. However, because the image backup does not differentiate various types of data on the medium 22, such as files, the image backup does not readily support selective restoration of selected application programs or other selected contents.

In order to provide application program-specific backup and restore capability for application programs such as the application programs “App #1” and “App #2” stored on the hard disk (or a logical partition thereof) or other non-volatile storage medium 22 of the target computer 20, an application program-specific backup program or program suite 50 is provided. The program suite 50 includes an application backup program 52 that copies program files, library files, applications registry entries, and other information pertaining to a selected application program to a backup non-volatile storage medium. The backed up information provides a complete record of the state of the application program including its current configuration at the time the application program backup is performed.

In the networked computer system 10 the backup medium is the non-volatile storage medium 16 included with or connected to the network server computer 14. A corresponding application restore program 54 selectively restores the application program backup by selectively copying the backup file contents to the target non-volatile storage medium 22. Because the backup file contains a complete record of the state of the application program including its current configuration at the time the backup was made, the restore program 54 restores the application program together with its configuration at the time the backup was performed.

A backup database 56 includes pointers or other identifying information that identifies files and other information pertaining to selected applications which should be recorded during application program backup to record complete information on the application program and its configuration. Such information pertaining to selected programs includes, among other items, identification of default parameters, program settings, and other configuration entries stored in the applications registry of the target non-volatile medium 22. The database 56 of the application programs backup suite 50 includes such information for “App #1” and for “App #2”, and so provides application program-specific backup capability for those two applications. The application program backup suite 50 is readily adapted to provide application program-specific backup capability for additional or other application programs by including corresponding application program-specific information in the backup database 56. Although the non-volatile storage medium 16 on which the backup files are stored is shown in FIG. 1 as being separate from the backup database 56, in a preferred embodiment the backup database 56 is physically stored on the same non-volatile storage medium as the backup files.

The application program backup program 52 accesses the application program-specific information contained in the backup database 56 to determine which files, flash interface memory contents, applications registry entries, and so forth to backup which should be backed up in order to provide complete information for the application restore program 54 to restore the application program together with its configuration and other settings that were in effect at the time the application program backup was made.

In one suitable embodiment, a user manually invokes the application backup program 52 whenever a configuration change or other modification of the application program is made. However, this manual approach has a substantial disadvantage in that the user may neglect to perform such application backups on a timely basis. Moreover, the user may be unaware that a change has been made to the application program if that change is effected by installation or modification of a different program that uses common library files, applications program registry entries, or the like.

Hence, in the preferred illustrated embodiment, an application program backup manager 60 periodically inventories the target non-volatile storage medium 22 and/or other storage medium that stores the application program and associated configuration information. Specifically, on a nightly, weekly, or other predetermined basis an inventory processor 62 of the application backup manager 60 accesses the backup database 56 to identify programs, contents of the flash interface memory 24, entries in the applications registry, or like stored data that pertain to the application program for which application program-specific backup information is being maintained.

The inventory processor 62 inventories the files and other data associated with or pertaining to the application program, searching for files or other information which has been modified since the last application program backup was performed. Identification of changed files, applications registry entries, or the like is determined based upon file dates, or with reference to an operating system log, or by comparison with the last application program backup. Alternatively, the application program backup suite 50 can include a memory-resident program (not shown) that is loaded by the operating system of the target computer 20 during computer startup and continuously monitors computer operations to maintain a log of changes to files, applications registry entries, and the like which are identified in the backup database 56 as pertaining to the selected application program.

If one or more changes to files and/or other information pertaining to the selected application program are identified, a change classifier component 64 of the application program backup manager 60 classifies the change as one of normal and suspicious. Normal changes are changes which are typically expected in the course of maintenance of the application program, such as adding or deleting authorized user profiles, adding known support files, or the like. Suspicious changes are changes which may indicate an inadvertent modification performed by another application program (such as an update to a library file), or a change introduced maliciously such as by infection of the application program by a virus. Preferably, any suspicious changes are reported to the user at the target computer 20 and/or to a system administrator at the administration computer 30 by a user notification module 66.

If normal changes but no suspicious changes are detected by the inventory processor 62, the application program backup manager preferably invokes the application program backup program 52 to perform an update application program backup. If one or more detected changes are identified as suspicious by the change classifier 64, the application backup program 52 is invoked in addition to performing the one or more notifications by the user notification module 66. Alternatively, invocation of the application backup program 52 is delayed until the notified person provides authorization to perform the update application program backup.

Preferably, each update application program backup is written to a separate file which is dated as shown by exemplary contents of the non-volatile storage medium 16. By writing to a new update application program backup file rather than overwriting the previous application program backup file, a history of changes to the application program is generated and maintained. The user can later decide to restore the application program to a previous configuration of a selected date, such as prior to infection by a virus or prior to an inadvertent configuration change by another program, by restoring a selected application program backup that suitably dates to just prior to the undesirable program modification.

To avoid creating an excessively large number of application program backup files, a backup file manager component 68 of the application program backup manager 60 preferably selectively deletes the oldest backup on a predetermined periodic basis or schedule. An older backup file is deleted if (1) a number of application program backup files for the selected application exceeds a selected number, and (2) a time interval between a present date and the creation date of the older application program backup file exceeds a selected time interval. The criteria (1) and (2) ensure that backups are maintained at least going back the selected time interval, and further ensure that at least the selected number of backups are retained.

The application program-specific backup program suite 50 is described herein as a modular suite in which application program-specific information is isolated in a backup database 56. In this arrangement, the application backup program 52 and the application backup manager 60 are generic programs, and the suite 50 is readily modified to perform backups for additional or other application programs by updating the backup database 56. Similarly, if the application program is modified by the manufacturer such that additional files, applications registry entries, or other non-volatile memory contents need to be stored to perform a complete backup (e.g., due to a version upgrade of the application program), the backup database 56 is suitably updated to include pointers or other identifying information for those memory contents. Preferably, the backup database 56 is updateable by the user or a system administrator to include new files associated with the application program. For example, in a word processing application program the user may wish to include one or more commonly used macro files in the backup database 56 to ensure that the most current configuration of these macro files is backed up.

Alternatively, the application backup program and the application program manager can be integrally configured for a particular application program by integrating the application program-specific information regarding the files and other stored information pertaining thereto directly into the backup and manager programs. Moreover, the various program components of the suite 50 can be arranged otherwise than is shown in FIG. 1. It is even contemplated to integrate the various components of the suite 50 into a single program that performs the backup, restore, and management functions as well as contains the application program-specific information integrated therein. Moreover, the image backup program 40 shown separately in FIG. 1 can instead be an integral part of the program suite 50 or of the integrated single-program embodiment of the application program backup.

The application program backup suite 50 is readily applied for performing backups of more than one application program. For example, application program backups for both “App #1” and “App #2” are maintained by the system 10 shown in FIG. 1. The application backup manager 60 performs separate inventories for each application program, and separately, selectively invokes the application program backup program 52 for a selected application program if changes to the application program are detected.

Similarly, in the integrated embodiment in which the application program-specific information is integrated into the application program backup program or suite, separate application program backup programs or suites for each application program for which backup is desired are suitably included in the system 10 to provide backup for the selected plurality of application programs.

Those skilled in the art will further appreciate that the image backup program 40 and the program-specific backup program or program suite 50 can be integrated into the networked computer system 10 in a variety of ways. In one suitable embodiment, the backup software 40, 50 are stored on the non-volatile storage medium 16 included with or accessed by the network server 14. In another suitable embodiment, the backup programs 40, 50 are stored on the non-volatile storage medium 22 of the target computer 20. In yet another suitable embodiment, the backup programs 40, 50 are stored on a non-volatile storage medium (not shown) included with or accessed by a computer other than the network server 14 and the target computer 20, such as the system administrator's computer 30 or the exemplary other computer 32. Moreover, the various components of the application program-specific backup program suite 50 can be stored on different storage media or on different computers. For example, the program files 52, 54, 60 are suitably stored on a drive that is dedicated to software storage, while the backup files and the backup database 56 are suitably stored on a drive that is dedicated to data storage.

Those skilled in the art will still further appreciate that the image backup program 40 and the program-specific backup program or program suite 50 can be maintained and executed on any one of the target computer 20, the network server computer 14, the system administrator's computer 30, or other computer 32. Moreover, backups can be performed for different instances of the application program disposed at different computers using a single set of the backup programs 40, 50 or different sets of the backup programs 40, 50 disposed at different computers, or using a combination thereof.

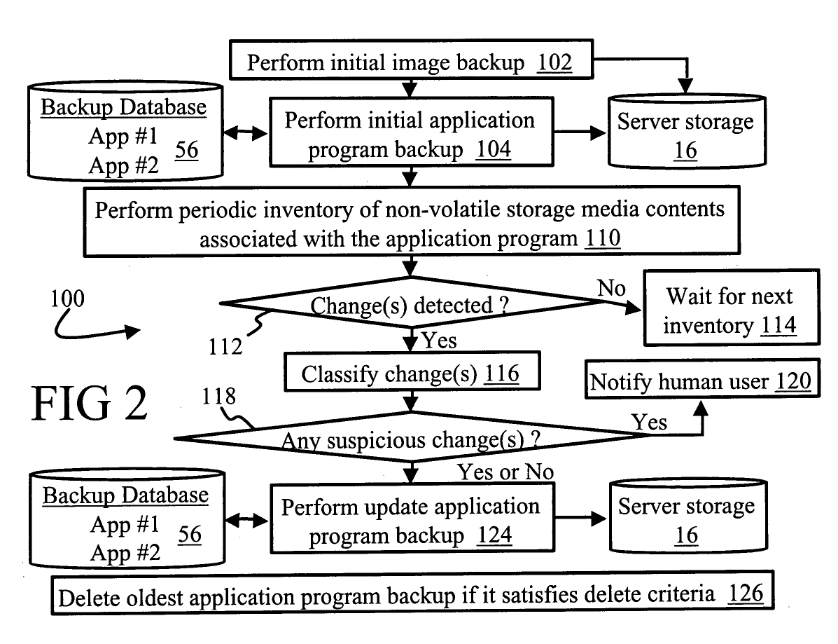

With continuing reference to FIG. 1 and with further reference to FIG. 2, a preferred application program backup method 100 is described. The method 100 is suitably practiced after initial installation of the operating system and the program application on the target computer 20. Optionally, the method 100 can be initiated after a period of usage of the application program; that is, the backup method 100 can be practiced to provide application backup and restoration on an existing computer.

An initial image backup is performed in a step 102 using the image backup program 40. In the illustrated networked system of FIG. 1, the image backup is stored to the non-volatile storage medium 16 included in or connected with the network server computer 14. An initial application program backup is performed in a step 104. The backup database 56 is accessed to determine the files, applications registry entries, contents of the flash memory 24 or other auxiliary non-volatile memory, and the like which should be recorded to provide complete information for a complete restoration of the application program in the event such restoration is desired or becomes necessary. In the illustrated networked system of FIG. 1, the initial application program backup is stored to the network server non-volatile memory 16, and is preferably dated to identify when the initial application program backup was performed. Each program backup preferably contains additional coordinating information such as a directory of which files were backed up, information on the backup methodology, file compression information if applicable, a backup program version identification, and the like. Furthermore, the backup database 56 is optionally updated each time an application backup is performed to include updated information on the files, registry entries, and other information which should be included in future backups.

The backup steps 102, 104 provide complete initial backup information. Subsequently, the files, applications registry entries, flash memory contents, and the like pertaining to the application program are periodically inventoried in a step 110 to check for changes to the application program. In a decision step 112, if no changes are detected, the application program backup suite 50 exits in a step 114 until the next scheduled inventory.

If, however, at the decision step 112 one or more changes to the application program is detected, each detected change is classified in a step 116 as either a normal change or a suspicious change. At a decision step 118, if any suspicious changes are identified then the user, system administrator, or other appropriate human is notified in a step 120. Preferably, the notification step 120 provides information about which file, applications registry entry, or so forth contains the change, along with the date that the change occurred and other information which can help the notified human determine the source and desirability of the suspicious change.

Responsive to one or more detected changes (suspicious or normal), an update application program backup is performed in a step 124. The backup database 56 is accessed to determine the files, applications registry entries, contents of the flash memory 24 or other auxiliary non-volatile memory, and the like which should be recorded to provide complete information for a complete restoration of the application program in the event such restoration becomes necessary. In the illustrated networked system of FIG. 1, the update application program backup is stored to the network server non-volatile memory 16, and is preferably dated to identify when each update application program backup was performed. The backup database 56 is optionally also updated during the update backup step 124 to include any additions, deletions, or modifications to the list of files, registry entries, and the like which should be included in future update application program backups.

Because the update application backup is preferably stored in a new backup file, the backup file manager 68 is preferably invoked in a step 126 to selectively delete the oldest application program backup file if: (1) the oldest file is older than a selected time period, and (2) the number of application program backup files corresponding to the selected application program exceeds a selected number. The backup file manager 60 is preferably performed on a predetermined periodic schedule, e.g. on a weekly, monthly, or other schedule which is independent of backup file creation, and performs selective deletions of dated backup files of all application programs for which the backup system 50 maintains backups. Optionally, however, the backup file manager 60 is invoked immediately after a new backup file is created.

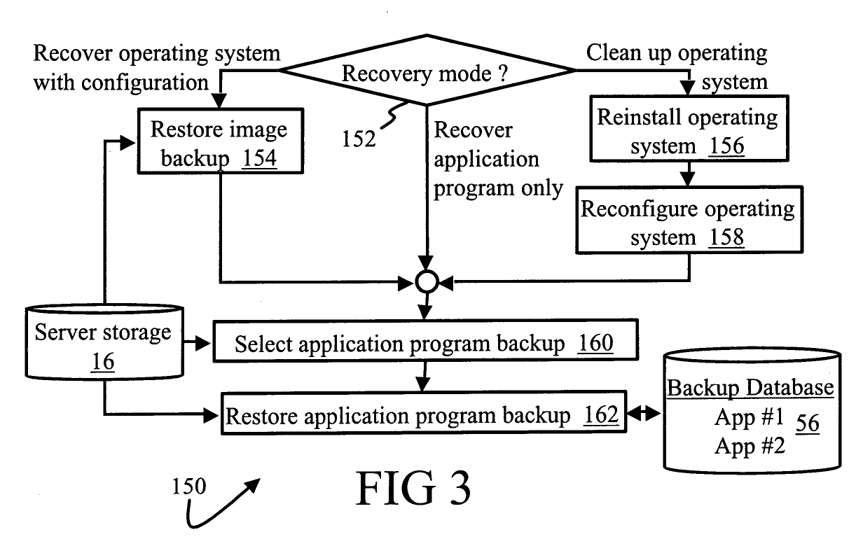

With continuing reference to FIGS. 1 and 2, and with further reference to FIG. 3, a preferred application program restoration method 150 is described. At a decision step 152, the recovery mode is selected. A first recovery mode is suitably performed to recover the operating system with its configuration parameters after a loss or failure of the non-volatile storage medium 22 due to a hard disk crash, a viral infection, an inadvertent formatting of a logical partition, or the like. In this first recovery mode, a step 154 restores the image backup which was created by the image backup program 40 in the step 102 of the backup method 100. The image backup restoration is performed by a restore component of the image backup program 40, by a separate image restore program (not shown), by data transfer commands of the network 12, or other suitable means. The step 152 restores the operating system and any application programs to the state corresponding to when the image backup step 102 was performed.

A second recovery mode is suitably performed in an operating system cleanup to recover the operating system and selected application programs without extraneous contents such as programs that are no longer used, fragmented disk sectors, or the like. The method 150 using the second recovery mode is preferably performed after a reformatting of the non-volatile storage medium 22 or a logical partition thereof responsive to a viral infection, an excessively fragmented disk, or the like. In this second recovery mode, in a step 156 the operating system is reinstalled from distribution disks, by downloading the operating system from the network 12, or the like. Optionally, the reinstall step 156 includes installing an operating system upgrade. The reinstalled operating system is configured by the user in a step 158.

A third recovery mode is suitably performed to recover the application program to a state of the application program existing prior to installation of a conflicting application or other problematic event, where it is desired to recover the application program without otherwise modifying or affecting the operating system and other application programs. In this case the operating system is neither restored nor reinstalled. That is, the steps 154, 156, 158 are omitted.

Regardless of the recovery mode selected in the decision step 152, in a step 160 the user selects an application program backup for restoration. As seen in FIG. 1, the backup non-volatile storage medium 16 preferably includes a number of application program backups reflecting various states in the temporal evolution of the application program. If, for example, the last update application program backup was performed responsive to changes in the application program which were determined to have resulted from a viral infection, then the user preferably will select an application program backup performed just prior to the backup containing the viral infection. If, however, the user wishes to reinstall the application program to its status just prior to a disk or logical partition reformatting or a hard disk failure, then the user will preferably select the latest application program backup which contains the most recent changes to the application program.

In a step 162, the application restore program 54 restores the selected application program backup. The restore program 54 accesses the network server non-volatile storage medium 16 to read the selected application program backup. Optionally, the backup database 56 is also accessed to identify where the backed up information should be copied to. Alternatively, the application program backup itself includes pointers or other information indicating where the backed up information should be copied to. Optionally, the backup database 56 is updated to reflect the restored condition of the application program.

In the recovery modes in which the operating system is restored or reinstalled, the user will typically want to restore more than one application program. For example, both “App #1” and “App #2” are preferably restored after a system crash. To do so, the selection and restore steps 160, 162 are repeated for each application program. However, if it is critical to get a particular application up and running as quickly as possible, then that application program can be restored and executed. Later, at the user's convenience the less critical application programs can be restored.

Although the preferred embodiments have been described with reference to backup and restore operations, other applications of the application program backup suite 50 and the methods 100, 150 are also contemplated. For example, those skilled in the art will recognize an inherent advantage in the reporting of suspicious application program changes in the step 120 of the backup method 100. As is known in the art, computer viruses frequently include a substantial latency period between initial infection (i.e. modification of the application program to include the virus instructions) and subsequent malicious virus manifestations such as data corruption, file deletion, hard drive reformatting, gloating screen messages, and the like. During the latency period, the virus distributes replicas of itself among programs or other contents of non-volatile storage media of the infected computer, and/or distributes replicas of itself to other non-volatile storage media via the network 12 or portable non-volatile storage media such as floppy disks.

The application program backup suite 50 provides the user with an early warning of a computer virus infection. At the first period inventory 110 performed after the application program is infected by a virus, the modified file or other content will be detected at the step 112 and classified as a suspicious modification at the step 116, and the user will be notified at the step 120. The user thus becomes aware of the suspicious change and can perform anti-virus diagnostics and countermeasures before the virus causes damage. Early detection also can limit the spread of viruses.

Those skilled in the art will particularly appreciate that the application program backup suite 50 detects virus infections even if the particular virus is not a known virus that is identifiable by anti-virus monitoring software. This is because an unidentified virus that infects the application program will produce a detectable suspicious change, even through that change is not specifically identifiable as a particular virus.

Those skilled in the art will recognize that the application program restoration method 150 can be suitably practiced to install the application together with its configuration information on another computer, such as the other computer 32. In this case, the image backup restoration step 154 is omitted, and the application program restoration step 162 is instructed to copy the backup information to the other computer 32. By this approach, the application program including configuration information is ported to the other computer 32 without reformatting the hard drive of the other computer 32 or otherwise destroying its contents.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

Having thus described the preferred embodiments, the invention is now claimed to be:

1. A method for backing up and restoring an application program including an application program configuration, the application program associated with a computer that includes an operating system with a common applications registry, the method comprising:
creating an image backup of one or more storage media that store files associated with the application program;
creating an initial application program backup of the application program including backing up files associated with the application program;
periodically inventorying the one or more storage media to detect a change in a file associated with the application program; and
responsive to a detected change, creating an update application program. backup of the application program including backing up files associated with the application program.

2. The method as set forth in claim 1, wherein the creating of an update application program backup does not overwrite the initial application program backup or any previous update application program backup.

3. The method as set forth in claim 2, wherein each application program backup is dated with a creation date.

4. The method as set forth in claim 3, further including:
deleting an application program backup having an oldest creation date of a plurality of application program backups responsive to both of:
a number of application program backups exceeding a selected number, and
a time interval between a present date and the oldest creation date exceeding a selected time interval.

5. The method as set forth in claim 3, further including:
restoring the application program to a state corresponding to a selected creation date by copying information contained in an application program backup having the selected creation date onto the one or more storage media.

6. The method as set forth in claim 5, wherein the restoring further includes:
prior to the copying of information contained in the application program backup, copying the image backup onto the one or more storage media.

7. The method as set forth in claim 1, further including:
responsive to a detected change, categorizing the detected change as one of normal and suspicious; and
responsive to a suspicious detected change, notifying a human of the suspicious detected change.

8. The method as set forth in claim 7, further including:
responsive to a suspicious detected change, waiting to receive an approval from the human before creating the update application program backup.

9. The method as set forth in claim 1, further including:
repeating the steps of creating an initial application program backup, periodically inventorying the one or more storage media to detect a change in a file associated with the application program, and creating an update application program backup responsive to a detected change for at least a second application program.

10. The method as set forth in claim 1, wherein the step of periodically inventorying the one or more storage media to detect a change in a file associated with the application program is performed responsive to a regular operation of the computer.

11. The method as set forth in claim 1, wherein:
the step of periodically inventorying further includes detecting a change in contents of a non-volatile memory which pertain to the application program; and
the step of creating an update application program backup further includes recording the contents of the non-volatile memory which pertain to the application program.

12. The method as set forth in claim 1, wherein the files associated with the application program include the common applications registry, and the steps of creating an initial application program backup and of creating an update application program backup each further include:
recording entries of the common application registry that pertain to the application program.

13. The method as set forth in claim 1, further including:
transferring the application program including the application program configuration to a second computer by copying information contained in an application program backup onto the one or more storage media that are accessible by the second computer.

14. A system for backing up and restoring an application program including an application program configuration, the application program associated with a computer that includes an operating system with a common applications registry, the system comprising:
an application program backup software program for creating an application program backup of the application program including copies of files associated with the application program that reside on one or more storage media and copies of entries of the common applications registry pertaining to the application program, the application program backup software program assigning a creation date to each created application program backup corresponding to a date of creation thereof;
a backup coordinating software program that invokes the application program backup software program to create an initial application program backup, periodically inventories the one or more storage media to detect one of a change in a file associated with the application program and a change in an entry of the common applications registry pertaining to the application program, and invokes the application program backup software program to create an update application program backup responsive to a detected change; and
a restore software program for restoring the application program to a state corresponding to a selected creation date by copying information contained in an application program backup having the selected creation date onto the one or more storage media.

15. The system as set forth in claim 14, further including:
an application program backup manager that deletes an application program backup responsive to:
a number of application program backups exceeding a selected number, and
a time interval between a present date and the creation date of the application program backup that exceeds a selected time interval.

16. The system as set forth in claim 14, further including:
an image backup software program for creating an image backup of the one or more storage media; and
an image restore software program for copying the image backup onto the one or more storage media;
wherein upon initiation of execution of the restore software program and responsive to a selected user input, the restore software program invokes the image restore software program prior to the copying of information contained in an application program backup onto the one or more storage media.

17. The system as set forth in claim 14, wherein the computer is connected to a server system, and the application program backup is stored on the server system.

18. The system as set forth in claim 14, further including:
an application program backup database accessed by the application program backup software program and the backup coordinating software program that identifies the files and the entries of the common applications registry that pertain to the application program.

19. The system as set forth in claim 18, further including:
a second application program backup database accessed by the application program backup software program and the backup coordinating software program that identifies files and the entries of the common applications registry that pertain to a second application program, wherein the application program backup software program and the backup coordinating software program cooperate to periodically create an application program backup of the second application program responsive to a detected change in one of a file associated with the second application program and an entry of the common applications registry pertaining to the second application program.

20. The system as set forth in claim 14, wherein the backup coordinating software program includes:
a change classifier that classifies a detected change as one of a normal change and a suspicious change; and
a user notification module that notifies a user of a detected suspicious change.

21. The system as set forth in claim 14, wherein:
the backup coordinating software program further detects a change in contents of a non-volatile memory which pertain to the application program; and
the application program backup software program records the contents of the non-volatile memory which pertain to the application program in the created application program backup.
